(19) United States
(12) Patent Application Publication
(10) Pub. No.: US 2004/0234236 A1
(43) Pub. Date: Nov. 25, 2004

(54) Data recording and reproduction apparatus displaying channels

(76) Inventor: Jun Torobu, Osaka (JP)

Correspondence Address: Jonathan P. Osha, Osha & May L.L.P., Suite 2800, 1221 McKinney St., Houston, TX, 77010, US

(21) Appl. No.: 10/847,114

(22) Filed: May 17, 2004

(30) Foreign Application Priority Data
May 23, 2003 (JP) 2003-146607(P)

(51) Int. Cl. H04N 5/91; H04N 7/00; H04B 7/216; G11B 5/00

(52) U.S. Cl. 386/46; 360/7

(57) ABSTRACT

A data recording and reproduction apparatus includes a control unit that generates, and stores in a hard disk, channel information data including information of a changed channel in accordance with a channel change designation received via an operation device while program data is being stored in the hard disk, and an output terminal for connection with an external device. At the time of time shift playback of the program data, every time the channel information data is read from a temporary storage region, the control unit stores the changed-channel information included in the channel information data in a memory, and generates a channel display signal based on the changed-channel information and externally outputs the signal via the output terminal.

### BACKGROUND OF THE INVENTION

1. Field of the Invention

The present invention relates to a data recording and reproduction apparatus for recording and reproducing television broadcast provided with a time shift function, and more particularly to display of channels corresponding to programs to be recorded and reproduced.

2. Description of the Background Art

There is conventionally known a data recording and reproduction apparatus having a so-called time shift function, which, in receipt of a television signal (hereinafter, “TV signal”) included in analog television broadcast via a tuner, encodes the signal into MPEG (Moving Picture Expert Group) data by an MPEG encoder and temporarily stores the MPEG data in a recording medium such as a hard disk, and, while continuing the recording, enables reading and displaying of the MPEG data from a playback point that is time-shifted by rewinding or the like.

A conventional example of such a display apparatus provided with the time shift function has the following configuration (see, e.g., Japanese Patent Laying-Open No. 2001-309268). The apparatus has a time shift portion that stores a received displaying signal in a recording medium and outputs the same in a time-shifted manner. Specifically, an intelligent function outputs the displaying signal of a specified channel after time shifting the same by control of the-time shift portion, unless there is input a user operation for the time shift.

With regard to display during the time shift playback, the conventional data recording and reproduction apparatus having the time shift function provides display indicating that the time shift playback is in progress, as described in Japanese Patent Laying-Open No. 2001-309268. As to display of a channel (hereinafter, “CH”) employing an on screen display (OSD), however, it only displays the CH corresponding to the MPEG data being temporarily stored. The apparatus does not display the CH corresponding to the MPEG data being reproduced from the playback point designated by time shifting.

### SUMMARY OF THE INVENTION

An object of the present invention is to provide a data recording and reproduction apparatus which, when performing reproduction of program data from a playback point designated by time shifting, enables display of a changed CH on an external device, at a time point when CH change is effected during temporary storage of the program data.

Another object of the present invention is to provide a data recording and reproduction apparatus which, when performing reproduction of program data from a playback point designated by time shifting, enables display of a changed CH on a display device provided at a casing, at a time point when CH change is effected during temporary storage of the program data.

Yet another object of the present invention is to provide a data recording and reproduction apparatus which, when performing reproduction of program data from a playback point designated by time shifting, enables display of a changed CH at a time point when CH change is effected during temporary storage of the program data and, concurrently, display of the CH corresponding to the program being temporarily stored.

According to an aspect of the present invention, the data recording and reproduction apparatus includes a control unit for temporarily storing program data including at least one of video data and audio data and simultaneously reproducing the program data in a time-shifted manner. The control unit includes a circuit for generating channel information data including information of a changed channel that is changed in accordance with a channel change designation while the program data is being stored in a temporary storage region in the form of a ring buffer, a circuit for storing the channel information data in the temporary storage region, between the program data before channel change corresponding to the channel before being changed and the program data after the channel change corresponding to the changed channel, an information storage circuit for storing the changed-channel information included in the channel information data every time the channel information data is read from the temporary storage region when the program data is read from a time-shifted reproduction position, and a circuit for performing, based on the changed-channel information, at least one of display of the channel corresponding to the program data by a display unit and external output of a display signal of the channel via an interface.

According to another aspect of the present invention, the data recording and reproduction apparatus performs at least one of recording and reproduction of data. The data recording and reproduction apparatus includes: an input unit for receiving an external input designation; a receive unit for receiving program data including at least one of video data and audio data corresponding to a channel selected based on the input designation; a storage conversion unit for converting a format of the program data to a format suitable for storage; and a program storage unit for storing the converted program data. The program storage unit includes a temporary storage region in the form of a ring buffer for temporarily storing the program data. The data recording and reproduction apparatus further includes: a reproduction conversion unit for converting the format of the program data stored in the temporary storage region to a format suitable for reproduction; and a control unit for controlling an operation of the data recording and reproduction apparatus. The control unit includes a read circuit for sequentially reading the program data in the temporary storage region from a read position based on a designation received via the input unit while the program data is being stored in the temporary storage region, a circuit for generating channel information data including information of a changed channel that is changed in accordance with a channel change designation received via the input unit while the program data is being stored in the temporary storage region, and a circuit for storing the channel information data in the temporary storage region, between the program data before channel change corresponding to the channel before being changed and the program data after the channel change corresponding to the changed channel.

Preferably, the data recording and reproduction apparatus further includes an interface for connection with an external device. In this case, the control unit may further include an information storage circuit for storing information of the channel. The information storage circuit may include a circuit for storing the changed-channel information included in the channel information data, every time the channel information data is read from the temporary storage region, at the time of reading of the program data by the read circuit. The control unit may further include a signal generation circuit for generating a channel display signal for displaying a reproduction channel based on the changed-channel information, a circuit for generating a channel display image based on the channel display signal, and a circuit for externally outputting the channel display image via the interface.

Preferably, the information storage circuit further includes a circuit for storing recording channel information corresponding to the changed channel every time the channel change designation is received via the input unit. In this case, the channel display signal may include reproduction and recording channel display signals for displaying the reproduction channel and a recording channel generated by the signal generation circuit based on the changed-channel information and the recording channel information.

Preferably, the data recording and reproduction apparatus further includes a display unit for performing display of the channel corresponding to the program data. In this case, the control unit may further include an information storage circuit for storing information of the channel. The information storage circuit may include a circuit for storing the changed-channel information included in the channel information data, every time the channel information data is read from the temporary storage region, at the time of reading of the program data by the read circuit. The control unit may further include a signal generation circuit for generating a channel display signal for displaying a reproduction channel based on the changed-channel information, and a circuit for performing the channel display by the display unit based on the channel display signal.

Preferably, the information storage circuit further includes a circuit for storing recording channel information corresponding to the changed channel every time the channel change designation is received via the input unit. In this case, the channel display signal may include reproduction and recording channel display signals for displaying the reproduction channel and a recording channel generated by the signal generation circuit based on the changed-channel information and the recording channel information.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram showing a configuration of an information recording and reproduction apparatus 100 according to an embodiment of the data recording and reproduction apparatus of the present invention.

FIG. 2 schematically shows contents of memory regions included in a hard disk 22.

FIG. 3 schematically illustrates data to be written into a time shift region 22A in the information recording and reproduction apparatus 100 of the embodiment of the present invention.

FIG. 4A schematically illustrates a data structure of MPEG data 28, and FIG. 4B schematically illustrates a data structure of CH information data 30.

FIG. 5 is an operational flowchart at the time when a system control circuit 18 generates and writes CH information data into the hard disk 22.

FIG. 6 is an operational flowchart at the time when a reproduction CH corresponding to MPEG data read from the time shift region 22A is displayed during the time shift playback.

FIG. 7A is a time chart at the time when MPEG data is temporarily stored in the time shift region 22A, and FIG. 7B is a time chart at the time when the reproduction CH is displayed during the time shift playback in accordance with a user designation of a playback point.

### DESCRIPTION OF THE PREFERRED EMBODIMENTS

Hereinafter, embodiments of the present invention will be described in detail with reference to the drawings. In the drawings and the following description, the same reference characters denote the same or corresponding components having the same names and functions, and thus, detailed description thereof will not be repeated where appropriate.

### First Embodiment

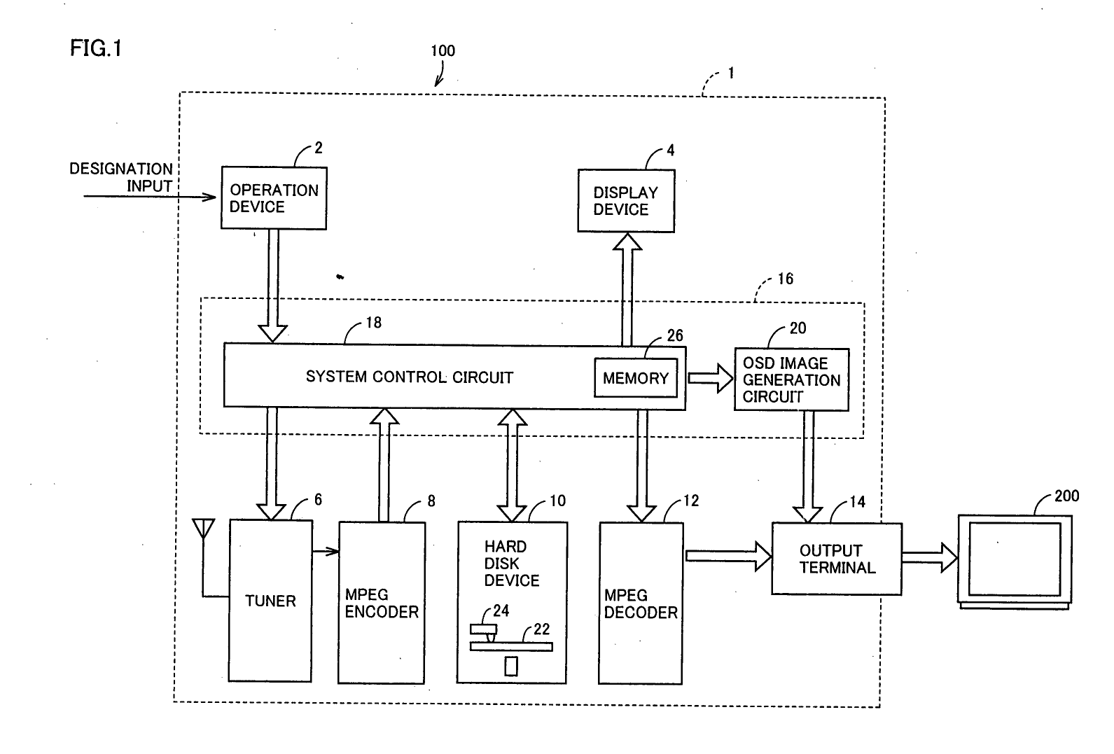

Referring to FIG. 1, the information recording and reproduction apparatus 100 includes a casing 1, an operation device 2 for receiving a designation input from a user, a display device 4 for displaying reproduction and recording information and others, a tuner 6 for receiving a TV signal included in television broadcast, an MPEG encoder 8 for MPEG-encoding the TV signal supplied from tuner 6, a hard disk device 10 for storing the encoded MPEG data, an MPEG decoder 12 for decoding the MPEG data to the TV signal, an output terminal 14 for externally outputting the TV signal, and a control unit 16 for controlling the operation of information recording and reproduction apparatus 100.

Control unit 16 includes a system control circuit 18 having a memory 26 for storing the reproduction and recording information, and an OSD image generation circuit 20 for generating an OSD image based on the information stored in memory 26.

Hard disk device 10 includes a hard disk 22, and a recording and reproduction head 24 for writing data to and reading data from hard disk 22.

The TV signal includes at least one of video and audio signals.

The operation of information recording and reproduction apparatus 100 according to the first embodiment of the present invention is now described.

System control circuit 18 enables information recording and reproduction apparatus 100 to operate in accordance with various operations of the user received via operation device 2.

The “various operations” may include operations to designate a broadcast CH, designate a recorded program, instruct recording, instruct reproduction, stop recording, stop reproduction, and others.

Operation device 2 provides system control circuit 18 with various operation signals in accordance with the user operations. Operation device 2 may be provided on the surface of casing 1, or may be a remote controller separated from casing 1 of information recording and reproduction apparatus 100.

When there is a user input designating CH change via operation device 2, system control circuit 18 sends a CH designation signal of analog television broadcast (of the National Television Standards Committee (NTSC) system, the Phase Alternation by Line (PAL) system, the Sequential Couleur A Memoire (SECAM) system or the like) to tuner 6, and tuner 6 receives an analog television broadcast wave of the designated CH. Tuner 6 demodulates the received analog television broadcast wave to obtain a TV signal and provide the signal to MPEG encoder 8. MPEG encoder 8 subjects the TV signal to an MPEG coding process based on an encode control signal of system control circuit 18, to convert the TV signal to MPEG data. The converted MPEG data is written to hard disk device 10 by system control circuit 18. Hard disk device 10 writes the MPEG data to hard disk 22, and reads the written MPEG data from hard disk 22 in accordance with a read control signal of system control circuit 18. MPEG decoder 12 performs an MPEG decoding process on the read MPEG data based on a decode control signal of system control circuit 18, to convert the MPEG data to a TV signal. The converted TV signal is output to an external device via output terminal 14 by system control circuit 18. The external device may be a display 200, although it is not limited thereto.

OSD image generation circuit 20 generates an information display image for displaying an image corresponding to each of various information display signals applied from system control circuit 18. The generated information display image is externally output via output terminal 14. The information display image may include a display image of the channel corresponding to the program, for example.

Display device 4 displays reproduction and recording information and others based on the various information display signals applied from system control circuit 18.

Display 200 displays the TV signal output from information recording and reproduction apparatus 100 and the information display image generated by OSD image generation circuit 20.

As described above, information recording and reproduction apparatus 100 according to the present invention converts received TV signals to MPEG data, and temporarily stores the MPEG data in hard disk device 10. It sequentially reads the stored MPEG data and coverts the same again to the TV signals, to allow the user to watch the video or listen to the sound based on the received TV signals in real time. In the following explanation, reproduction in the case where TV signals received at tuner 6 are converted to MPEG data and the MPEG data are temporarily stored and simultaneously reproduced from a playback point that is time-shifted by rewinding or the like, is referred to as “time shift playback”.

Memory regions included in hard disk 22 and for writing data therein are now described.

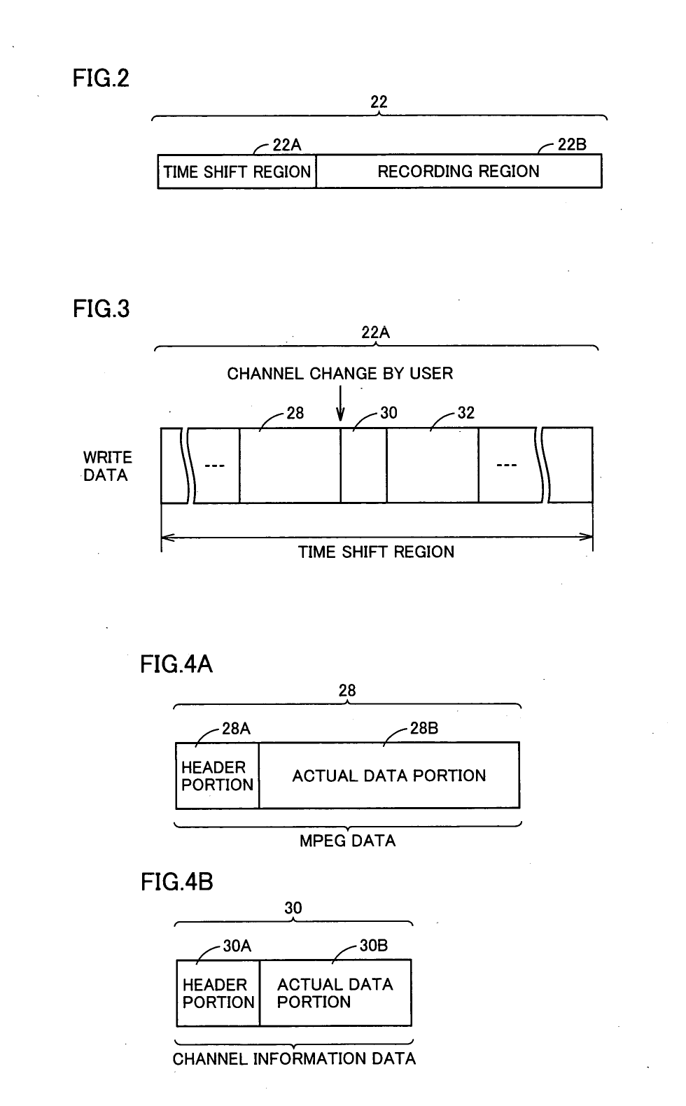

Referring to FIG. 2, hard disk 22 includes a time shift region 22A in the form of a ring buffer for performing the time shift playback, and a recording region 22B for recording information for a long period of time. The sizes of time shift region 22A and recording region 22B in hard disk 22 are determined based on the information input by a user via operation device 2. In hard disk 22, positions of time shift region 22A and recording region 22B are managed as addresses of the respective regions are recorded in memory 26 within system control circuit 18.

An operation of information recording and reproduction apparatus 100 at the time when MPEG data is written into hard disk 22 is now described.

In information recording and reproduction apparatus 100, the TV signals received from tuner 6 are subjected to an MPEG coding process in MPEG encoder 8. The converted MPEG data are sequentially written into time shift region 22A included in hard disk 22 within hard disk device 10 by means of a recording and reproduction head 24. When the amount of data within time shift region 22A exceeds its capacity, time shift region 22A is overwritten with data from its start address, since it is a ring buffer.

An operation of information recording and reproduction apparatus 100 upon the time shift playback, i.e., at the time when the MPEG data converted from the received TV signals are written into time shift region 22A and simultaneously the data included in hard disk 22 are read from an address corresponding to the designated playback point as described above, is now explained.

In information recording and reproduction apparatus 100, the time shift playback is performed in accordance with the designation input of the user via operation device 2. In response to the user designation of the playback point, system control circuit 18 starts sequential reading of data within time shift region 22A, from the address corresponding to the designated playback point. System control circuit 18 reads the data sequentially in order of address. The read MPEG data are subjected to an MPEG decoding process in MPEG decoder 12 for conversion into TV signals. The converted TV signals are output via output terminal 14 to display 200 connected to output terminal 14.

Referring to FIG. 3, time shift region 22A includes CH information data 30 that is written in response to the CH change designation based on the user designation via operation device 2, MPEG data 28 corresponding to a CH before the CH change, and MPEG data 32 corresponding to the changed CH.

In information recording and reproduction apparatus 100, the TV signals received from tuner 6 are subjected to an MPEG coding process, and the converted data are written as MPEG data 28 into hard disk device 10. At this time, when a CH change designation is input via operation device 2 by a user operation, system control circuit 18 generates CH information data 30 including information of the changed CH in accordance with the CH change designation. System control circuit 18 causes the generated CH information data 30 to be sequentially written into time shift region 22A from an address following the end address of MPEG data 28 written prior to the CH change. MPEG data 32 corresponding to the TV signals received after the CH change are sequentially written into time shift region 22A from an address following the end address of the written CH information data 30.

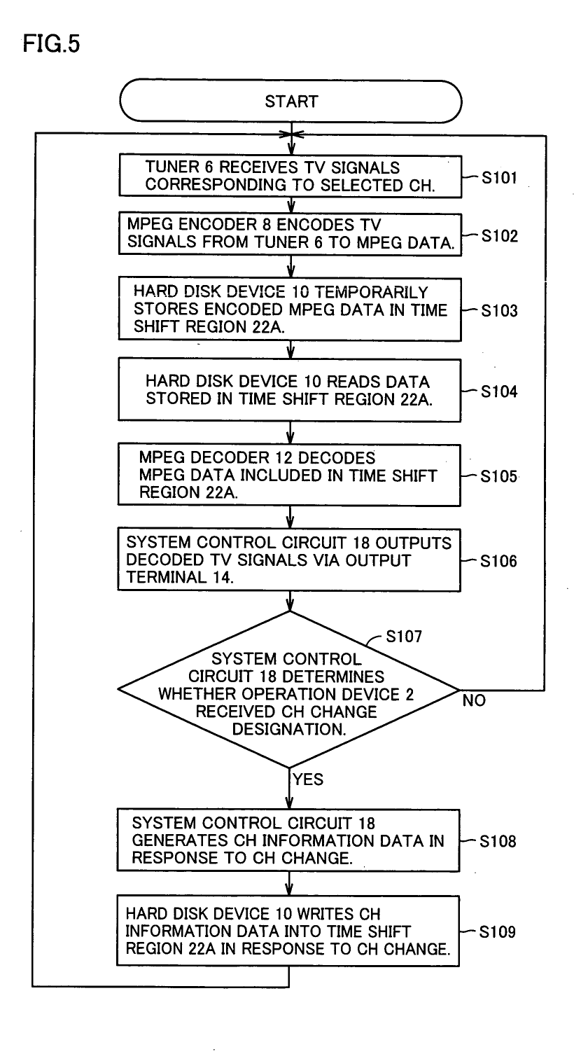

Referring to FIG. 4A, MPEG data 28 can largely be divided into a header portion 28A and an actual data portion 28B. Header portion 28A includes information indicating that the data is moving picture data of MPEG format, and management information such as reproduction time information, or bibliographic information. Actual data portion 28B includes the body of moving picture data.

Referring to FIG. 4B, CH information data 30 can largely be divided into a header portion 30A and an actual data portion 30B. Header portion 30A includes information indicating that the data is CH information data. As such, system control circuit 18 can read the header of data to determine whether the data read from hard disk device 10 is the MPEG data including moving pictures or the CH information data including the CH information. Actual data portion 30B includes information of the CH changed during the temporary storage of MPEG data corresponding to a program.

System control circuit 18 starts reading of data within time shift region 22A from the address corresponding to a playback point designated by a user. Each time reading the CH information data, system control circuit 18 stores the information of the CH included in the CH information data in memory 26. At this time, system control circuit 18 generates a CH display signal based on the CH information included in memory 26. The generated CH display signal is supplied to OSD image generation circuit 20, which in turn generates an information display image based on the CH display signal. The generated information display image is output via output terminal 14 to an external device. When display 200 is connected to information recording and reproduction apparatus 100, display 200 displays a CH based on the received information display image.

An operation of information recording and reproduction apparatus 100 at the time when it generates CH information data in accordance with a CH change designation of a user during the temporary storage of MPEG data and writes the CH information data into hard disk 22 is now described.

Referring to FIG. 5, firstly, tuner 6 receives TV signals corresponding to a selected CH (S101).

Next, MPEG encoder 8 encodes the TV signals received at tuner 6 to MPEG data, based on an encode control signal of system control circuit 18 (S102).

Hard disk device 10, in response to a write control signal of system control circuit 18, temporarily stores the encoded MPEG data in time shift region 22A in order of address (S103).

Next, hard disk device 10, in response to a read control signal of system control circuit 18, sequentially reads the data stored in time shift region 22A (S104).

MPEG decoder 12 decodes the read MPEG data to TV signals, based on a decode control signal of system control circuit 18 (S105).

System control circuit 18 externally outputs the TV signals having undergone the MPEG decoding process via output terminal 14 (S106).

Here, system control circuit 18 determines whether operation device 2 has externally received a CH change designation (S107).

If it is determined that there is no CH change designation in S107, system control circuit 18 returns the process to S101.

If it is determined that there has been the CH change designation in S107, then system control circuit 18 generates CH information data including information of the changed CH in accordance with the CH change (S108).

Next, system control circuit 18 writes the CH information data into time shift region 22A following the MPEG data written immediately before the CH change (S109).

System control circuit 18 then returns the process to S101. After the received TV signals are converted to MPEG data, system control circuit 18 sequentially writes the converted MPEG data following the CH information data written in S109.

An operation of information recording and reproduction apparatus 100 according to the first embodiment of the present invention at the time when it displays the channel corresponding to the program during the time shift playback while it sequentially reads the temporarily stored MPEG data from the address corresponding to the designated playback point, is now described.

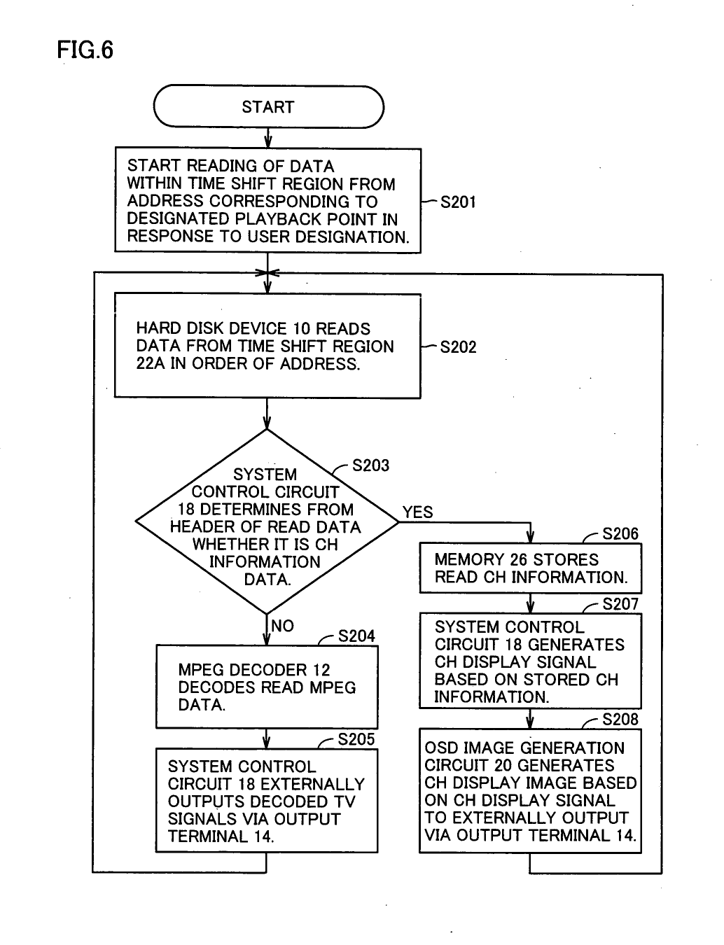

Referring to FIG. 6, firstly, the TV signals received at tuner 6 are encoded to MPEG data. While the converted MPEG data are being temporarily stored in time shift region 22A, a user designates a playback point of the MPEG data stored in time shift region 22A by an input instructing rewinding or the like via operation device 2.

System control circuit 18 then starts the time shift playback from the address in time shift region 22A corresponding to the playback point designated by the user (S201).

When the time shift playback is started, hard disk device 10 reads the data from time shift region 22A in order of address, in accordance with the read control signal of system control circuit 18 (S202).

Subsequently, system control circuit 18 determines whether the data read from time shift region 22A is CH information data or not, based on the header of the read data (S203).

If the read data does not correspond to the CH information data in S203, then hard disk device 10 reads the actual data included in the MPEG data based on the read control signal of system control circuit 18. MPEG decoder 12 then decodes the read MPEG data based on the decode control signal of system control circuit 18 (S204).

System control circuit 18 then externally outputs the decoded TV signals via output terminal 14 (S205).

System control circuit 18 then returns the process to S202.

If the read data is the CH information data in S203, then hard disk device 10 reads the actual data included in the CH information data, based on the read control signal of system control circuit 18. Memory 26 stores the CH information included in the read CH information data, based on a memory control signal of system control circuit 18 (S206).

System control circuit 18 then generates a CH display signal for displaying the CH, based on the CH information written in memory 26 (S207).

OSD image generation circuit 20 generates a CH display image based on the CH display signal applied from system control circuit 18. OSD image generation circuit 20 externally outputs the CH display image via output terminal 14 (S208).

System control circuit 18 then returns the process to S202.

CH display in information recording and reproduction apparatus 100 of the first embodiment of the present invention at the time when MPEG data are temporarily stored and simultaneously reproduced in a time-shifted manner is now described.

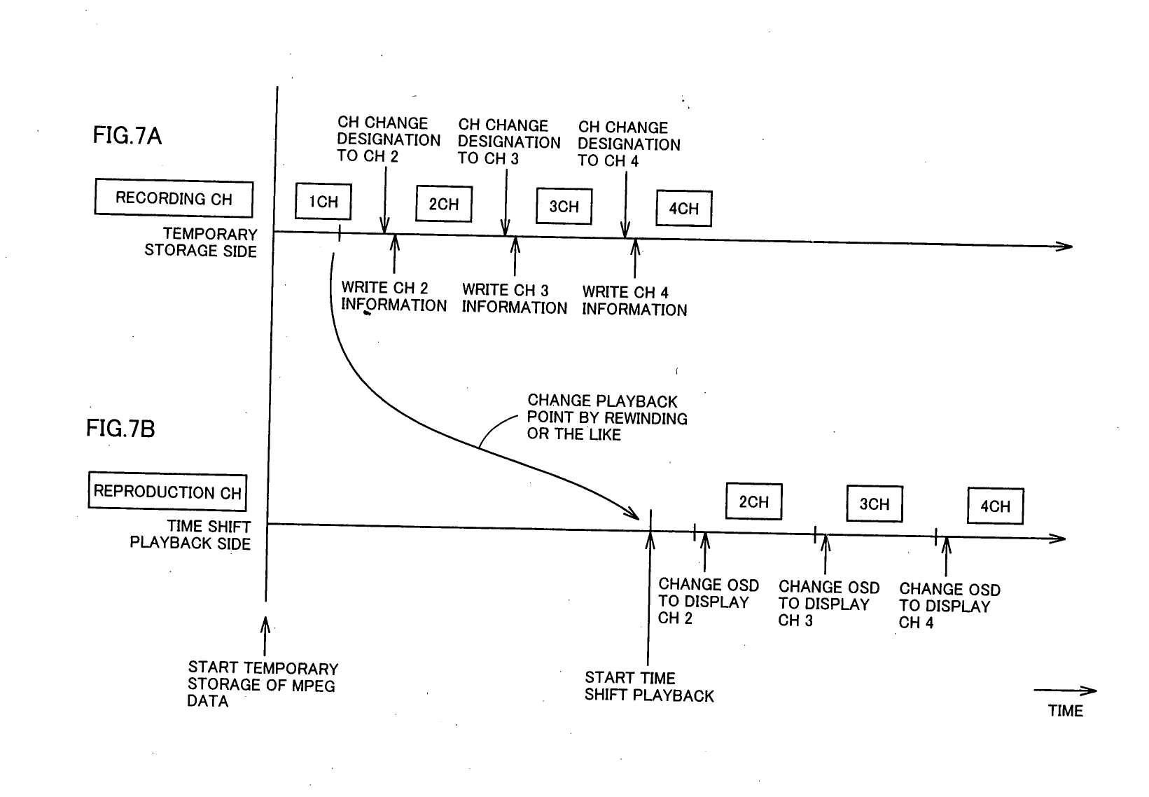

Referring to FIG. 7A, firstly, at the start of temporary storage of MPEG data, the MPEG data corresponding to a program on CH 1 is temporarily stored in time shift region 22A. In receipt of the user designation to change the channel to CH 2 via operation device 2, system control circuit 18 writes the information data of CH 2 into time shift region 22A. Similarly, in response to the user's channel change designations to CH 3 and to CH 4 via operation device 2, system control circuit 18 writes the information data of CH 3 and CH 4, respectively, into time shift region 22A.

Referring to FIG. 7B, information recording and reproduction apparatus 100 receives a user instruction designating a playback point in the middle of CH 1 by rewinding or the like. During the time shift playback, when system control circuit 18 reads the information data of CH 2, it writes the information data of CH 2 into memory 26 before reproducing the MPEG data corresponding to CH 2. System control circuit 18 generates a CH display signal of the reproduction CH based on the information data of CH 2 written into memory 26. OSD image generation circuit 20 generates a CH display image of the reproduction CH based on the CH display signal applied from system control circuit 18. OSD image generation circuit 20 externally outputs the CH display image of the reproduction CH via output terminal 14, which allows CH display of CH 2 on display 200 during the time shift playback. Similarly, information recording and reproduction apparatus 100 enables outputs of CH displays of CH 3 and CH 4 upon reading of the information data of CH 3 and CH 4, before reproduction of the MPEG data corresponding to CH 3 and CH 4, respectively.

As described above, according to information recording and reproduction apparatus 100 of the first embodiment of the present invention, information of a CH selected by a user designation can be written as channel information data into time shift region 22A, between the MPEG data corresponding to the CH before the channel change and the MPEG data corresponding to the CH after the channel change.

Accordingly, when time shift playback is performed, the CH information data can be read at the time of CH change. As such, display of the reproduction CH corresponding to the MPEG data being reproduced can be output on the screen of display 200 connected to information recording and reproduction apparatus 100.

As a result, a user can confirm the CH of the reproduced program during the time shift playback.

### Second Embodiment

An information recording and reproduction apparatus according to a second embodiment of the present invention is now described. The configuration of the information recording and reproduction apparatus of the second embodiment is identical to the configuration of information recording and reproduction apparatus 100 shown in FIG. 1 in terms of hardware; it only differs in terms of software with which-control unit 16 described in the first embodiment reads channel information data from hard disk 22 and externally outputs a CH display image via output terminal 14. Thus, description of the hardware configuration of information recording and reproduction apparatus 100 will not be repeated here.

The operation of information recording and reproduction apparatus 100 of the second embodiment of the present invention differs from that of information recording and reproduction apparatus 100 of the first embodiment in the following points.

Referring to the operational flowchart of FIG. 6 where information recording and reproduction apparatus 100 displays the reproduction CH corresponding to the MPEG data read from time shift region 22A during the time shift playback, in S208, the CH display signal generated by system control circuit 18 based on the CH information included in memory 26 is applied to display device 4, which in turn displays the CH based on the received CH display signal. As such, display device 4 can display the reproduction CH corresponding to the program being time-shift reproduced.

At this time, system control circuit 18 may provided the CH display signal not only to display device 4 but also to OSD image generation circuit 20 as in the first embodiment. In such a case, OSD image generation circuit 20 generates a CH display image based on the CH display signal, and externally outputs the same via output terminal 14.

That is, information recording and reproduction apparatus 100 according to the second embodiment of the present invention enables at least one of display of the reproduction CH by display device 4 and external output of the CH display image by OSD image generation circuit 20.

As described above, according to information recording and reproduction apparatus 100 of the second embodiment of the present invention, the information of a selected CH by a user designation can be written as CH information data into time shift region 22A, between the MPEG data corresponding to the CH before channel change and the MPEG data corresponding to the CH after the channel change.

As such, when time shift playback is conducted, the CH information data can be read at the time of the CH change. Accordingly, display device 4 provided on casing 1 can display the reproduction CH corresponding to the MPEG data being reproduced.

As a result, the user can confirm the CH of the reproduced program during the time shift playback by means of display device 4.

Further, at least one of display of the reproduction CH by display device 4 in the second embodiment of the present invention and output of the display image of the reproduction CH to display 200 in the first embodiment may be implemented. As a result, the user can confirm the CH of the reproduced program via at least one of display device 4 and display 200.

### Third Embodiment

An information recording and reproduction apparatus according to a third embodiment of the present invention is now described. The configuration of the information recording and reproduction apparatus of the third embodiment is identical to that of information recording and reproduction apparatus 100 in FIG. 1 in terms of hardware; it only differs in software configuration with which control unit 16 described in the first embodiment reads channel information data from hard disk 22 and outputs a CH display image via output terminal 14. Thus, description of the hardware configuration of information recording and reproduction apparatus 100 will not be repeated here.

The operation of information recording and reproduction apparatus 100 according to the third embodiment differs from that of information recording and reproduction apparatus 100 of the first embodiment in the following points.

System control circuit 18 generates CH display signals to enable not only display of a reproduction CH corresponding to MPEG data being time-shift reproduced but also display of a recording CH corresponding to a program being temporarily stored.

Specifically, system control circuit 18 generates channel information data and writes the same into time shift region 22A every time the channel is changed by a user designation during the temporary storage of a program, and concurrently, stores the changed-channel information in memory 26. System control circuit 18 then generates the CH display signals for displaying the reproduction CH and the recording CH based on the channel information stored in memory 26.

OSD image generation circuit 20 generates a CH display image based on each CH display signal supplied from system control circuit 18. OSD image generation circuit 20 then outputs the generated CH display images to an external device via output terminal 14. Thus, during the time shift playback, the reproduction CH corresponding to the MPEG data being time-shift reproduced is displayed on the external device every time the channel information data included in time shift region 22A is read, along with the CH display of the recording CH corresponding to the program being temporarily stored.

Alternatively, during the time shift playback, display device 4 may display the reproduction CH corresponding to the MPEG data being time-shift reproduced every time the channel information data included in time shift region 22A is read, along with the CH display of the recording CH corresponding to the program being temporarily stored, based on the CH display signals supplied from system control circuit 18.

That is, system control circuit 18 enables at least one of output of the CH display images by OSD image generation circuit 20 and display of the CHs by display device 4.

As described above, according to information recording and reproduction apparatus 100 of the third embodiment of the present invention, when time shift playback is conducted by designation of a user, the reproduction CH corresponding to the MPEG data being time-shift reproduced and the recording CH corresponding to the program being temporarily stored are displayed concurrently, so that the user can confirm, without confusion, the reproduction CH of the MPEG data being time-shift reproduced and the recording CH of the program being temporarily stored.

At this time, it may be configured to display the reproduction CH on display 200 and display both the recording CH and the reproduction CH on display device 4. Alternatively, it may be configured to display the reproduction and recording CHs on display 200 and display the reproduction CH on display device 4. As a result, the user can confirm the CH of the program being time-shift reproduced and the CH of the program being temporarily stored with display device 4 and display 200.

As described above, the information of the CH changed by a user designation can be written into time shift region 22A as channel information data, between the MPEG data corresponding to the CH before channel change and the MPEG data corresponding to the CH after the channel change. Thus, when time shift playback is conducted, the CH information data can be read upon the CH change.

Accordingly, information recording and reproduction apparatus 100 can output display of, e.g., at least the reproduction CH corresponding to the reproduced MPEG data via output terminal 14. That is, at least the reproduction CH can be displayed on the screen of display 200.

Alternatively, display device 4 provided on casing 1 may display at least one of the reproduction and recording CHs.

Still alternatively, both of the reproduction and recording CHs may be displayed on the screen of display 200, or both of the reproduction and recording CHs may be displayed on display device 4.

As a result, the user can confirm the CH of the reproduced program during the time shift playback, on the screen of display 200 or by means of display device 4.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data recording and reproduction apparatus having control means for temporarily storing program data including at least one of video data and audio data and simultaneously reproducing the program data in a time-shifted manner, wherein
said control means includes
means for generating channel information data including information of a changed channel that is changed in accordance with a channel change designation while said program data is being stored in a temporary storage region in the form of a ring buffer,
means for storing said channel information data in said temporary storage region, between the program data before channel change corresponding to said channel before being changed and the program data after the channel change corresponding to said changed channel,
information storage means for storing said changed-channel information included in said channel information data every time said channel information data is read from said temporary storage region when said program data is read from a time-shifted reproduction position, and
means for performing, based on said changed-channel information, at least one of display of said channel corresponding to said program data by display means and external output of a display signal of said channel via an interface.

2. A data recording and reproduction apparatus performing at least one of recording and reproduction of data, comprising:
input means for receiving an external input designation;
receive means for receiving program data including at least one of video data and audio data corresponding to a channel selected based on said input designation;
storage conversion means for converting a format of said program data to a format suitable for storage;
program storage means for storing converted said program data,
said program storage means including a temporary storage region in the form of a ring buffer for temporarily storing said program data;
reproduction conversion means for converting the format of said program data stored in said temporary storage region to a format suitable for reproduction; and
control means for controlling an operation of said data recording and reproduction apparatus,
said control means including
read means for sequentially reading said program data in said temporary storage region from a read position based on a designation received via said input means while said program data is being stored in said temporary storage region,
means for generating channel information data including information of a changed channel that is changed in accordance with a channel change designation received via said input means while said program data is being stored in said temporary storage region, and
means for storing said channel information data in said temporary storage region, between the program data before channel change corresponding to said channel before being changed and the program data after the channel change corresponding to said changed channel.

3. The data recording and reproduction apparatus according to claim 2, further comprising an interface for connection with an external device, wherein
said control means further includes
information storage means for storing information of said channel,
said information storage means including means for storing said changed-channel information included in said channel information data, every time said channel information data is read from said temporary storage region, at the time of reading of said program data by said read means,
signal generation means for generating a channel display signal for displaying a reproduction channel based on said changed-channel information,
means for generating a channel display image based on said channel display signal, and
means for externally outputting said channel display image via said interface.

4. The data recording and reproduction apparatus according to claim 3, wherein
said information storage means further includes means for storing recording channel information corresponding to said changed channel every time said channel change designation is received via said input means, and
said channel display signal includes reproduction and recording channel display signals for displaying said reproduction channel and a recording channel generated by said signal generation means based on said changed-channel information and said recording channel information.

5. The data recording and reproduction apparatus according to claim 2, further comprising display means for performing display of said channel corresponding to said program data, wherein
said control means further includes
information storage means for storing information of said channel,
said information storage means including means for storing said changed-channel information included in said channel information data, every time said channel information data is read from said temporary storage region, at the time of reading of said program data by said read means,
signal generation means for generating a channel display signal for displaying a reproduction channel based on said changed-channel information, and
means for performing said channel display by said display means based on said channel display signal.

6. The data recording and reproduction apparatus according to claim 5, wherein
said information storage means further includes means for storing recording channel information corresponding to said changed channel every time said channel change designation is received via said input means, and
said channel display signal includes reproduction and recording channel display signals for displaying said reproduction channel and a recording channel generated by said signal generation means based on said changed-channel information and said recording channel information.

7. A data recording and reproduction apparatus having a control unit for temporarily storing program data including at least one of video data and audio data and simultaneously reproducing the program data in a time-shifted manner, wherein
said control unit includes
a circuit for generating channel information data including information of a changed channel that is changed in accordance with a channel change designation while said program data is being stored in a temporary storage region in the form of a ring buffer,
a circuit for storing said channel information data in said temporary storage region, between the program data before channel change corresponding to said channel before being changed and the program data after the channel change corresponding to said changed channel,
an information storage circuit for storing said changed-channel information included in said channel information data every time said channel information data is read from said temporary storage region when said program data is read from a time-shifted reproduction position, and
a circuit for performing, based on said changed-channel information, at least one of display of said channel corresponding to said program data by a display unit and external output of a display signal of said channel via an interface.

8. A data recording and reproduction apparatus performing at least one of recording and reproduction of data, comprising:
an input unit for receiving an external input designation;
a receive unit for receiving program data including at least one of video data and audio data corresponding to a channel selected based on said input designation;
a storage conversion unit for converting a format of said program data to a format suitable for storage;
a program storage unit for storing converted said program data,
said program storage unit including a temporary storage region in the form of a ring buffer for temporarily storing said program data;
a reproduction conversion unit for converting the format of said program data stored in said temporary storage region to a format suitable for reproduction; and
a control unit for controlling an operation of said data recording and reproduction apparatus,
said control unit including
a read circuit for sequentially reading said program data in said temporary storage region from a read position based on a designation received via said input unit while said program data is being stored in said temporary storage region,
a circuit for generating channel information data including information of a changed channel that is changed in accordance with a channel change designation received via said input unit while said program data is being stored in said temporary storage region, and
a circuit for storing said channel information data in said temporary storage region, between the program data before channel change corresponding to said channel before being changed and the program data after the channel change corresponding to said changed channel.

9. The data recording and reproduction apparatus according to claim 8, further comprising an interface for connection with an external device, wherein
said control unit further includes
an information storage circuit for storing information of said channel,
said information storage circuit including a circuit for storing said changed-channel information included in said channel information data, every time said channel information data is read from said temporary storage region, at the time of reading of said program data by said read circuit,
a signal generation circuit for generating a channel display signal for displaying a reproduction channel based on said changed-channel information,
a circuit for generating a channel display image based on said channel display signal, and
a circuit for externally outputting said channel display image via said interface.

10. The data recording and reproduction apparatus according to claim 9, wherein
said information storage circuit further includes a circuit for storing recording channel information corresponding to said changed channel every time said channel change designation is received via said input unit, and
said channel display signal includes reproduction and recording channel display signals for displaying said reproduction channel and a recording channel generated by said signal generation circuit based on said changed-channel information and said recording channel information.

11. The data recording and reproduction apparatus according to claim 8, further comprising a display unit for performing display of said channel corresponding to said program data, wherein
said control unit further includes
an information storage circuit for storing information of said channel,
said information storage circuit including a circuit for storing said changed-channel information included in said channel information data, every time said channel information data is read from said temporary storage region, at the time of reading of said program data by said read circuit,
a signal generation circuit for generating a channel display signal for displaying a reproduction channel based on said changed-channel information, and
a circuit for performing said channel display by said display unit based on said channel display signal.

12. The data recording and reproduction apparatus according to claim 11, wherein
said information storage circuit further includes a circuit for storing recording channel information corresponding to said changed channel every time said channel change designation is received via said input unit, and
said channel display signal includes reproduction and recording channel display signals for displaying said reproduction channel and a recording channel generated by said signal generation circuit based on said changed-channel information and said recording channel information.
